(19) United States
(12) Patent Application Publication
(10) Pub. No.: US 2009/0226384 A1
(43) Pub. Date: Sep. 10, 2009

(54) ANTIMICROBIAL COMPOSITION CONTAINING TRICLOSAN AND AT LEAST ONE FUNCTIONALIZED HYDROCARBON

(75) Inventors: Tripitikumar Mukhopadhyay, Chennai (IN); Meenakshi Narayanan, Chennai (IN); Kavitha Kandasamy, Chennai (IN)

Correspondence Address: HAMRE, SCHUMANN, MUELLER & LARSON, P.C., P.O. BOX 2902, MINNEAPOLIS, MN, 55402-0902, US

(73) Assignee: CAVINKARE PRIVATE LIMITED, Chennai (IN)

(21) Appl. No.: 11/908,457

(22) PCT Filed: Sep. 14, 2006
(86) PCT No.: PCT/IN2006/000352

§ 371 Date: Sep. 12, 2007

(30) Foreign Application Priority Data
Jan. 3, 2006 (IN) 11/CHE/2006

(51) Int. Cl. A01N 31/14; A01P 1/00

(52) U.S. Cl. 424/49; 514/721; 424/65

(57) ABSTRACT

The invention disclosed in this application relates to a synergistic antimicrobial composition containing triclosan and at least one functionalized hydrocarbon and/or mixtures containing such functionalized hydrocarbons. The ratio of Triclosan to that of the functionalized hydrocarbon and/or mixtures containing such functionalized hydrocarbons may be in the range of 1:5-1:100. The composition of the present invention is useful as an antimicrobial composition which includes, but not limited to, hair care, skin care, oral care, surface cleaning and similar compositions used to cleanse and/or treat any living or non-living surface.

### FIELD OF INVENTION

The present invention relates to a synergistic antimicrobial composition, a process for its preparation and products incorporating the composition. The present invention, particularly, relates to an improved antimicrobial composition comprising an antimicrobial agent, such as, Triclosan (TCS) (Synonyms: 2,4,4′-trichloro-2′-hydroxydiphenyl ether; 5-Chloro-2-(2,4-dichlorophenoxy) phenol; Microban; Irgasan DP 300; Lexol 300; Sterzac; Cloxifenolum; Biofresh) and a functionalized hydrocarbon and/or mixtures containing such functionalized hydrocarbons and a process for preparing the said composition. By the term functionalized hydrocarbon, it is meant a saturated/unsaturated; linear/branched/cyclic hydrocarbon; having 6-20 carbon atoms; the functional groups present in the hydrocarbon being hydroxyl, carbonyl, carboxyl, amino groups or derivatives thereof. This invention, particularly, relates to compositions which exhibits unexpected and enhanced antimicrobial activity as compared to the inherent antimicrobial activities of the ingredients employed, due to synergy.

The composition of the present invention is useful as an antimicrobial composition which includes, but not limited to, hair care, skin care, oral care, hard surface cleaning and similar compositions used to cleanse and/or treat any living or nonliving surface. Accordingly, the synergistic antimicrobial composition of the present invention is applicable to the control of bacterial and fungal growth in cosmetic, personal care (hair care, skin care); home care products (hard surface and other surface treatments), and oral care. Such products include, but not limited to, shampoos, conditioners, hair wash powders, hair and body oils, gels, creams, lotions, cleansers, toners, liquid soaps, soaps, scrubs, microbicidal washes, toothpastes/gels, mouthwashes, deodorants, antiperspirants, surface cleaners and the like.

The chlorinated diphenyl ether, Triclosan (TCS), is an antimicrobial agent that has been employed for a variety of purposes for more than 20 years. It is used clinically, in oral hygiene products as well as in a wide range of consumer products. TCS has a broad range of activity that encompasses many, but not all types of Gram positive and Gram negative non-sporulating bacteria, some fungi and viruses. Bacterial spores are unaffected. (Russell A D Wither Triclosan?, Jour. Antimicrob. Chemo. (2004), 53: 693-695).

TCS is relatively non-toxic to humans and other mammals. It is also not found to have any carcinogenic, mutagenic or teratogenic effects. (Bhargava H N & Leonard P A: Triclosan—Applications and Safety. Am. Jour. Infect. Cont., (1996), 24 (3): 209-218).

However, recently a number of concerns about the overuse of TCS have been raised. These relate particularly to its linkage with ‘allergies’, ‘skin irritation’, ‘development of resistant strains’ and ‘dioxin contamination and destruction of fragile aquatic ecosystems’ (Glaser A: The ubiquitous Triclosan. Pesticides and You, (2004), 24 (3): 12-17). Therefore there is an urgent need to reduce the quantity of TCS used in products while retaining its antimicrobial efficacy.

There remains a very real and substantial need for antimicrobial compounds capable of effectively controlling and/or inhibiting microbial growth in health care, personal care and food industry. Because of stringent environmental regulations, there is a further need to provide biocidal compounds having enhanced antimicrobial effect, which are effective in lower doses than historically used. Use of lower amounts of antimicrobial has a favorable impact on the environment and allows users to realize significant cost savings.

Prior Art Knowledge on Synergism Between Antimicrobial and/or Other Ingredients.

U.S. Pat. No. 6,689,342 of Pan et al., relates to oral care compounds comprising an effective amount of at least one Tropolone compound in combination with at least one essential oil and a pharmaceutically acceptable oral carrier. They have claimed that the admixture of tropolone compound with antimicrobially active essential oil provides a synergistic antimicrobial effect.

U.S. Pat. No. 6,479,456 of Holzner relates to an antimicrobial perfuming composition comprising of perfuming ingredients having an antimicrobial activity of at least 80%, and an active ingredient which may be grapefruit pip, a fumatory extract, a fumaric acid or an ester of fumaric acid/lactic acid. Addition of perfuming composition (in combination with fumaric acid) with TCS/Triclocarbon was found to have synergistic antimicrobial effect. It was found that presence of the active ingredient (fumitory extract or fumaric acid or lactic acid) was critical in the perfuming ingredient to exhibit synergistic activity. Hence the antimicrobial composition comprises of three critical ingredients viz., perfuming agent, fumitory extract and TCS or triclocarbon to exhibit synergistic effect.

Jampani et al (WO 0141573) describes antimicrobial compositions comprising at least 30% alcohol (ethyl alcohol/isopropyl alcohol/n-propyl alcohol) and/or an effective amount of TCS in combination with an effective amount of phenoxyethanol, benzalkonium or benzethonium chloride and cocophosphatidyl-dimonium and an effective amount of plant extracts for disinfecting skin. The composition additionally contained an effective amount of essential oils like Australian Tea Tree oil, Lemongrass oil, Thyme oil, Lavender oil, and clove oil in combination. Essential oils were used to increase the emolliency, moisturization and penetration properties of the invention. No synergistic antimicrobial activity between TCS and essential oils used have been disclosed or claimed. Also, this composition is a mixture of several compounds and not a binary combination of an antimicrobial and an essential oil.

U.S. Pat. No. 6,515,007 of Murad, relates to a pharmaceutical composition for managing scalp conditions like dandruff, seborrhoeic dermatitis, psoriasis, folliculitis, and thinning hair. The composition includes a therapeutically effective amount of an acidic component having a hydroxy acid or tannic acid or a pharmaceutically acceptable salt thereof; a vitamin A component and an antigrowth agent preferably TCS, clotrimazole and the like, added as a preservative. Together the acidic component, Vitamin A compound and the antigrowth agent may facilitate exfoliation of dead skin, facilitate hydration of scalp and inhibit the presence of microbes and finally assist in scalp management. However no synergy has been claimed.

U.S. Pat. No. 6,152,152 of Reynen et al., relates to liquid dishwashing compositions comprising a surfactant, a hydrotope consisting of salts of cumene sulfonate, toluene sulfonate, xylene sulfonate, benzene sulfonate or mixtures thereof; an unsaturated aliphatic terpene alcohol or derivative (e.g. Geraniol, Nerol, Citronellol, Linalool etc.) and a phenolic compound like Eugenol and Thymol. It is a multicomponent synergistic composition.

Gaffney et al (U.S. Pat. No. 5,985,934) have presented synergistic admixtures of 2,4,4′-trichloro 2′-hydroxy diphenyl ether and 1,2-dibromo-2,4-dicyanobutane to give synergistic biocidal activities. This patent describes synergistic antimicrobial activities between 2 synthetic compounds. No functionalized hydrocarbon and/or mixtures containing such functionalized hydrocarbons have been disclosed in this binary mixture.

U.S. Pat. No. 6,147,120 of Swart et al., relates to a synergistic composition to treat skin and hair of people and animals, comprising of TCS, chlorhexidine gluconate and an alcohol (ethanol/isopropanol). The compositions were found to provide synergistic antimicrobial effects. They may be used as a single composition or individually in a sequential manner. However, all three components are critical for producing the synergistic effect in the resulting composition. No functionalized hydrocarbon and/or mixtures containing such functionalized hydrocarbons were used.

US Patent 20050019431 of Modak et al., relates to an antimicrobial composition comprising of a quaternium ammonium compound and an essential oil and/or an individual constituent thereof and comprising of 2 or more zinc salts. Synergistic antimicrobial activity was observed with this composition.

A review of the literature reveals that binary combination of an antimicrobial agent with functionalized hydrocarbons and/or mixtures containing such functionalized hydrocarbons to enhance the antimicrobial activity of the resulting composition has not been reported so far. Particularly, binary composition of TCS and functionalized hydrocarbon and/or mixtures containing such functionalized hydrocarbons have not been reported. In contrast to a multicomponent composition, a simple binary composition involving an antimicrobial such as TCS will make the product more economical and environmental friendly; which is the need of the hour.

By the term functionalized hydrocarbons, it is meant a saturated/unsaturated; linear/branched/cyclic hydrocarbon; having 6-20 carbon atoms; the functional groups present in the hydrocarbon being hydroxyl, carbonyl, carboxyl, amino groups or derivatives thereof. By way of examples mention is made to monoterpenes or mixtures containing such monoterpenes such as essential oils.

The use of the terms ‘synergistic’ and ‘synergistically effective’ used in the present invention means a biological effect created from the application of two or more agents to produce a biological effect that is greater than the sum of the biological effects produced by the application of the individual agents.

During the course of developing the present invention we observed that when the ingredients viz. an antimicrobial agent and a functionalized hydrocarbon and/or mixtures containing such functionalized hydrocarbons are used in combination, synergistic antimicrobial activity was observed. Excellent antimicrobial property was observed when specific amounts of the ingredients and in specific ratio are employed.

### OBJECTIVES OF THE PRESENT INVENTION

Therefore, the main objective of the present invention is to provide a synergistic antimicrobial composition containing an antimicrobial agent and at least one functionalized hydrocarbon and/or mixtures containing such functionalized hydrocarbons.

Another objective of the present invention is to provide a synergistic antimicrobial composition containing TCS as the antimicrobial agent and at least one functionalized hydrocarbon and/or mixtures containing such functionalized hydrocarbons.

According to yet another objective of the present invention there is provided a synergistic antimicrobial composition containing TCS and the functionalized hydrocarbon and/or mixtures containing such functionalized hydrocarbons in the ratio in the range of 1:5-1:100.

Yet another objective of the present invention is to provide a process for the preparation of a synergistic antimicrobial composition containing an antimicrobial agent and at least one functionalized hydrocarbon and/or mixtures containing such functionalized hydrocarbons.

Still another objective of the present invention is to provide a process for the preparation of an synergistic antimicrobial composition containing TCS as the antimicrobial agent and at least one functionalized hydrocarbon and/or mixtures containing such functionalized hydrocarbons.

According to another objective of the present invention there is provided products such as but not limited to, shampoo, gel, cream, lotions etc., containing the synergistic composition of the present invention

### SUMMARY OF THE INVENTION

Accordingly, the present invention provides a synergistic antimicrobial composition containing an antimicrobial agent and at least one functionalized hydrocarbon and/or mixtures containing such functionalized hydrocarbons.

According to another embodiment of the present invention there is provided a synergistic antimicrobial composition containing TCS as the antimicrobial agent and at least one functionalized hydrocarbon and/or mixtures containing such functionalized hydrocarbons.

According to yet another embodiment of the present invention there is provided a synergistic antimicrobial composition containing TCS and the functionalized hydrocarbon and/or mixtures containing such functionalized hydrocarbons in the ratio in the range of 1:5-1:100.

According to yet another embodiment of the present invention there is provided a process for the preparation of a synergistic antimicrobial composition which comprises mixing the antimicrobial agent and at least one functionalized hydrocarbon and/or mixtures containing such functionalized hydrocarbons.

According to yet another embodiment of the present invention there is provided a process for the preparation of a synergistic antimicrobial composition which comprises mixing TCS as the antimicrobial agent and at least one functionalized hydrocarbon and/or mixtures containing such functionalized hydrocarbons thereof, the ratio of TCS and functionalized hydrocarbon and/or mixtures containing such functionalized hydrocarbons being in the range of 1:5-1:100.

According to another embodiment of the present invention there is provided products such as, but not limited to, shampoo, gel, cream, lotions etc., containing the synergistic composition of the present invention

It may be noted that the activity of composition of the present invention is not due to the mere additive property of the ingredients, but due to a surprising synergistic activity.

### DETAILED DESCRIPTION OF THE INVENTION

In a preferred embodiment of the present invention the ratio of TCS:functionalized hydrocarbon and/or mixtures containing such functionalized hydrocarbons in the composition may be in the range of 1:5-1:100; preferably in the range of 1:10-1:90 and more preferably between 1:20-1:80.

In preferred embodiment, the composition of the present invention may be incorporated in products like shampoo, gel, cream, lotions etc., which may comprise a mixture of water, surfactants, thickeners, gelling agents, hydrophobic/hydrophilic polymers, emulsifying agents, emollients or their mixtures, humectants, perfumes, colours, functional ingredients and the like. The compositions of the invention may optionally further include one or more additional antimicrobial agents such as, but not limited to, antibacterial, antiviral, or antifungal agents. Examples of antimicrobial agents include, but not limited to, iodophores, iodine, benzoic acid, dehydroacetic acid, propionic acid, sorbic acid, methyl paraben, ethyl paraben, propyl paraben, butyl paraben, isobutyl paraben, cetrimide, chlorhexidine (free base and/or salts), other biguanides, chloroerosol, chloroxylenol, benzyl alcohol, bronopol, benzalkonium chloride, benzethonium chloride, ethanol, phenoxyethanol, phenyl ethyl alcohol, 2,4-dicholorobenzyl alcohol, thiomersal, clindamycin, erythromycin, benzoyl peroxide, mupirocin, bacitracin, polymixin B, DMDM Hydantoin (Glydant), GERMALL, Kathon CG, Phenonip, miconazole, fluconazole, itraconazole, etc.

The composition of the present invention may contain other ingredients normally employed in such composition, which will aid in the formulation and the use of the composition as a whole. Examples of such ingredients are well known to one skilled in the art. These include substances such as binders, emollients, preservatives, lubricants, colorants, perfumes and the like. Accordingly, when the surface contemplated is scalp/skin/mucous membrane, the composition of the invention may contain ingredients which are physiologically acceptable and which do not contain ingredients which will reverse or retard the action of the synergistic composition. If the surface is a hard non-living surface, suitably accepted ingredients may be present.

Products like gels, ointments, lotions, creams, incorporating the composition of the present invention, which may be applied topically to the skin or to the various mucus membranes of the body, including but not limited to those of the oral, nasal, vaginal or rectal cavities.

The details of the invention are given in the Examples provided below which are given only to illustrate the invention and therefore should not be construed to limit the scope of the invention.

The Examples provided below describe the preparation of the composition which may be incorporated into various products.

### Example 1

### Preparation of Composition Containing Triclosan and Lemongrass Oil in a Ratio of 1:20

300 mg of TCS was added to 6000 mg of LGO. They were mixed thoroughly, so that the TCS dissolved completely in LGO. The resultant composition was in an oil phase.

### Example 2

### Preparation of Composition Containing Triclosan and Lemongrass Oil in a Ratio of 1:80

30 mg of TCS was added to 2400 mg of LGO. They were mixed thoroughly, so that the TCS dissolved completely in LGO. The resultant composition was in an oil phase.

### Example 3

### Preparation of Composition Containing Triclosan and Citral in a Ratio of 1:20

300 mg of TCS was added to 6000 mg of Citral. They were mixed thoroughly, so that the TCS dissolved completely in Citral. The resultant composition was in an oil phase.

### Example 4

### Preparation of Composition Containing Triclosan and Citral in a Ratio of 1:80

30 mg of TCS was added to 2400 mg of Citral. They were mixed thoroughly, so that the TCS dissolved completely in Citral. The resultant composition was in an oil phase.

### Example 5

### Preparation of Composition Containing Triclosan and Nerol in a Ratio of 1:20

300 mg of TCS was added to 6000 mg of Nerol. They were mixed thoroughly, so that the TCS dissolved completely in Nerol. The resultant composition was in an oil phase.

### Example 6

### Preparation of Composition Containing Triclosan and Nerol in a Ratio of 1:80

30 mg of TCS was added to 2400 mg of Nerol. They were mixed thoroughly, so that the TCS dissolved completely in Nerol. The resultant composition was in an oil phase.

### Example 7

### Preparation of Composition Containing Triclosan and Geraniol in a Ratio of 1:20

300 mg of TCS was added to 6000 mg of Geraniol. They were mixed thoroughly, so that the TCS dissolved completely in Geraniol. The resultant composition was in an oil phase.

### Example 8

### Preparation of Composition Containing Triclosan and Geraniol in a Ratio of 1:80

30 mg of TCS was added to 2400 mg of Geraniol. They were mixed thoroughly, so that the TCS dissolved completely in Geraniol. The resultant composition was in an oil phase.

Illustrative synergistic compositions using other classes of antimicrobial agents such as, Climbazole (CMB), Zinc Pyrithione (ZPTO) and Ketoconazole (KTZ) with functionalized hydrocarbons and/or mixtures containing such functionalized hydrocarbons are described below.

### Example 9

### Preparation of Composition Containing Climbazole (CMB) and Lemongrass Oil (LGO) in a Ratio of 1:20

300 mg of CMB was added to 6000 mg of LGO. They were mixed thoroughly, so that the CMB dissolved completely in LGO. The resultant composition was in an oil phase.

### Example 10

### Preparation of Composition Containing ZPTO and Lemongrass Oil in a Ratio of 1:40

125 mg of ZPTO was added to 5000 mg of LGO. They were mixed thoroughly, so that the ZPTO dissolved completely in LGO. The resultant composition was in an oil phase.

### Example 11

### Preparation of Composition Containing Ketoconazole (KTZ) and Lemongrass Oil (LGO) in a Ratio of 1:80

30 mg of KTZ was added to 2400 mg of LGO. They were mixed thoroughly, so that the KTZ dissolved completely in LGO. The resultant composition was in an oil phase.

The following examples described below elucidates the biological efficacy of the individual ingredients of the composition and that of the composition of the present invention.

### Example 12

### Estimation of Minimum Inhibitory Concentration (MIC) of Triclosan, Lemongrass Oil, Citral, Nerol, Geraniol, Climbazole, Zinc Pyrithione, & Ketoconazole Individually

TCS, LGO, Citral, Nerol, Geraniol, CMB, ZPTO and KTZ were examined for antimicrobial activity individually. The following microbial strains were used:

| | |
|---|---|
| Staphylococcus aureus | MTCC 96 |
| Staphylococcus epidermidis | MTCC 435 |
| Bacillus subtilis | MTCC 441 |
| Candida albicans | MTCC 3017 |
| Aspergillus niger | MTCC 1344 |
| Malassezia furfur (Pityrosporum ovale) | MTCC 1374 |
| Malassezia restricta | CBS 7877 |

MIC value—is the lowest concentration of the antimicrobial agent required to inhibit growth of the microorganism was determined by the macrobroth double dilution method as per the NCCLS guidelines. (Reference Method for broth dilution antifungal susceptibility testing of Yeasts, Approved Standard; M27A, Vol. 17, No. 9, 1997 & Methods for dilution antimicrobial susceptibility tests for bacteria that grow aerobically; Approved Standard—5^{th} Ed., M7-A5, Vol. 20, No. 2, 2000. National Committee for Clinical Laboratory Standards, Wayne, Pa.).

### Step 1. Preparation of Stock Solution of Test Substance

The test substances viz., TCS, CMB, ZPTO, KTZ, LGO, Citral, Nerol & Geraniol were prepared as stock solutions. Weighed 10 mg of TCS, CMB, ZPTO, & KTZ individually and dissolved in 1 ml of solvent (IN NaOH for TCS and DMSO for CMB, ZPTO & KTZ) and diluted in 19 ml SDB. The concentration of the prepared substances was 500 μg/ml. Similarly, weighed 400 mg of LGO, Citral, Nerol & Geraniol individually and dissolved in 2 ml DMSO and diluted in 18 ml SDB. The concentration of LGO, Citral, Nerol & Geraniol was 20000 μg/ml. All test solutions were prepared afresh prior to determination of MIC.

### Step 2. Preparation of Inoculum

S. aureus, S. epidermidis and B. subtilis were cultured in Mueller Hinton Agar (MHA) for 24 hrs. at 37° C. 1-2 colonies were suspended in MHB overnight at 37° C. C. albicans and A. niger were cultured in Sabauraud Dextrose Agar (SDA) at 28° C. for 24 hrs and 4 days respectively. 1-2 colonies of C. albicans was suspended in SDB and cultured overnight at 28° C. Aspergillus spores were washed with physiological saline prior to testing. M. furfur was cultured in SDA with 1% Tween 80 for 72 hrs at 32° C. Colonies were suspended in SDB with 1% Tween 80 and incubated at 32° C. M. restricta was cultured in Dixon agar at 32° C. for 3-4 days. Colonies were suspended in saline prior to testing.

Colonies suspended in broth/saline were determined for counts photometrically. (Hammer K A, et al.: Antimicrob. Agents Chemo., (2000), 44(2): 467-469). The organisms were diluted such that the final concentration was 1×10⁶ cfu/ml for S. aureus, S. epidermidis and B. subtilis, 1×10⁵ cfu/ml for C. albicans and A. niger and 2×10³ cfu/ml for M. furfur and M. restricta.

### Step 3. Serial Dilution

Double fold serial dilutions were done with the test substance, such that the final concentration of TCS was between 250 μg/ml and 0.03 μg/ml; and that of functionalized hydrocarbon (Citral, Nerol, Geraniol) and/or mixtures containing such functionalized hydrocarbons (LGO) was between 10000 μg/ml-19.53 μg/ml. Inoculated organisms were added to the tubes and required controls were also set up in the assay to rule out contamination/inactivation of the test substance.

### Step 4. Incubation and Culture:

Tubes were incubated for 24 hrs at 37° C. for S. aureus, S. epidermidis and B. subtilis; at 28° C. for C. albicans; for 48 hrs at 28° C. for A. niger, 32° C. for M, furfur and M. restricta. At the end of the incubation period, 10 μl aliquots from each tube were spot inoculated onto Nutrient agar (for bacteria), SDA (for C. albicans & A. niger), SDA with 1% Tween 80 for M. furfur and Dixon Agar for M. restricta. The plates were incubated for 24 hrs at 37° C. (S. aureus, S. epidermidis & B. subtilis), at 28° C. (C. albicans); 3-4 days at 28° C. (A. niger), 48-72 hrs at 32° C. (M. furfur & M. restricta) when the colonies became visible.

### Step 5. Observation:

At the end of the incubation period, plates were checked for growth of colonies. The highest dilution which resulted in the inhibition of the growth of the organism was considered as the inhibitory concentration.

Table 1 shows the MIC values of the individual ingredients of the composition of the present invention.

TABLE 1
MIC values of individual tested ingredients.

| | | MIC (μg/ml) | | | | | | |
|---|---|---|---|---|---|---|---|---|
| S. | Test | | S. epider- | | | | | |
| No. | Ingredients | S. aureus | midis | B. subtilis | C. albicans | A. niger | M. furfur | M. restricta |
| 1 | TCS | 1.95 | 7.81 | 15.62 | 15.62 | 31.25 | 62.5 | 62.5 |
| 2 | LGO | 1250 | 625 | 10000 | 625 | 625 | 39.06 | 156.25 |
| 3 | Citral | 312.5 | 312.5 | 5000 | 156.25 | 625 | 39.06 | 156.25 |
| 4 | Nerol | 5000 | 1250 | 10000 | 1250 | 1250 | 156.25 | 312.5 |
| 5 | Geraniol | 5000 | 1250 | 2500 | 1250 | 5000 | 156.25 | 312.5 |
| 6 | CMB | — | — | — | — | — | 1.95 | — |
| 7 | ZPTO | — | — | — | — | — | 3.9 | — |
| 8 | KTZ | — | — | — | — | — | 0.48 | — |

### Example 13

### MIC value of combinations of TCS, CMB, ZPTO & KTZ (antimicrobials) and LGO, Citral, Nerol & Geraniol (Functionalized Hydrocarbon and/or Mixtures Containing Such Functionalized Hydrocarbon)

MIC values of the combinations of the composition of the present invention described in Examples 1-11 were determined.

### Preparation of Stock Solution of Test Substances:

a. Preparation for Testing Efficacy of the Composition in the Ratio 1:20 (Composition Described in Examples 1, 3, 5, 7 & 9)

140 mg of the sample was dissolved in 2 ml of Dimethyl Sulfoxide (DMSO) and further diluted in 18 ml of SDB. The final concentration of antimicrobial and functionalized hydrocarbon and/or mixtures containing such functionalized hydrocarbons in the mixture was 333.33 μg/ml and 6666.66 μg/ml respectively.

b. Preparation for Testing Efficacy of the Composition in the Ratio 1:40 (Composition Described in Examples 10)

205 mg of the sample was dissolved in 2 ml of Dimethyl Sulfoxide (DMSO) and further diluted in 18 ml of SDB. The final concentration of antimicrobial and functionalized hydrocarbon and/or mixtures containing such functionalized hydrocarbons in the mixture was 250 μg/ml and 10000 μg/ml respectively.

c. Preparation for Testing Efficacy of the Composition in the Ratio 1:80 (Composition Described in Examples 2, 4, 6, 8, & 11)

270 mg of the sample was dissolved in 2 ml of Dimethyl Sulfoxide (DMSO) and further diluted in 18 ml of SDB. The final concentration of antimicrobial and functionalized hydrocarbon and/or mixtures containing such functionalized hydrocarbons in the mixture was 166.66 μg/ml and 13333.33 μg/ml respectively.

These combinations were serially diluted and MIC determined against microorganisms as explained in Example 12. Tables 2-5 show that the concentration of the components of the combination where growth inhibition of the organism was achieved.

TABLE 2
Inhibitory concentration of the components of the
combinations (TCS & LGO) in different ratios.

| | | MIC (μg/ml) | | | |
|---|---|---|---|---|---|
| | | Example 1 | | Example 2 | |
| S. | | TCS + LGO (1:20) | | TCS + LGO (1:80) | |
| No. | Organism | TCS | LGO | TCS | LGO |
| 1 | S. aureus | 1.3 | 26.04 | 0.65 | 13.02 |
| 2 | S. epidermidis | 1.3 | 26.04 | 2.6 | 208.33 |
| 3 | B. subtilis | 0.65 | 13.02 | 1.3 | 104.16 |
| 4 | C. albicans | 5.2 | 104.16 | 1.3 | 104.16 |
| 5 | A. niger | 10.41 | 208.33 | 2.6 | 208.33 |
| 6 | M. furfur | 1.3 | 26.04 | 0.65 | 13.02 |
| 7 | M. restricta | 2.6 | 52.08 | 0.65 | 13.02 |

As seen from the Table 2, combinations of TCS with LGO in different ratios surprisingly exhibit pronounced lowering of MIC values of individual components compared to that of the parent compound over a wide compositional ranges and against a wide ranges of organisms.

TABLE 3
Inhibitory concentration of the components of the
combinations (TCS & Citral) in different ratios

| | | MIC (μg/ml) | | | |
|---|---|---|---|---|---|
| | | Example 3 | | Example 4 | |
| S. | | TCS + Citral (1:20) | | TCS + Citral (1:80) | |
| No. | Organism | TCS | Citral | TCS | Citral |
| 1 | S. aureus | 0.16 | 3.25 | 0.65 | 13.02 |
| 2 | S. epidermidis | 2.6 | 52.08 | 2.6 | 208.33 |
| 3 | B. subtilis | 5.2 | 104.16 | 2.6 | 208.33 |
| 4 | C. albicans | 2.6 | 52.08 | 0.65 | 13.02 |
| 5 | A. niger | 10.41 | 208.33 | 5.2 | 416.66 |
| 6 | M. furfur | 1.3 | 26.04 | 0.65 | 13.02 |
| 7 | M. restricta | 2.6 | 52.08 | 0.65 | 13.02 |

As seen from the Table 3, combinations of TCS with Citral in different ratios surprisingly exhibits pronounced lowering of MIC values of individual components compared to that of the parent compound over a wide compositional range and against a wide range of organisms

TABLE 4
Inhibitory concentration of the components of the
combinations (TCS & Nerol) in different ratios

| | | MIC (μg/ml) | | | |
|---|---|---|---|---|---|
| | | Example 5 | | Example 6 | |
| S. | | TCS + Nerol (1:20) | | TCS + Nerol (1:80) | |
| No. | Organism | TCS | Nerol | TCS | Nerol |
| 1 | S. aureus | 0.16 | 3.25 | 0.32 | 26.04 |
| 2 | S. epidermidis | 1.3 | 26.04 | 2.6 | 208.33 |
| 3 | B. subtilis | 2.6 | 52.08 | 2.6 | 208.33 |
| 4 | C. albicans | 10.41 | 208.33 | 2.6 | 208.33 |
| 5 | A. niger | 10.41 | 208.33 | 2.6 | 208.33 |
| 6 | M. furfur | 1.3 | 26.04 | 0.65 | 13.02 |
| 7 | M. restricta | 5.2 | 104.16 | 1.3 | 104.16 |

As seen from the Table 4, combinations of TCS with Nerol in different ratios surprisingly exhibit pronounced lowering of MIC values of individual components compared to that of the parent compound over a wide compositional ranges and against wide ranges of organisms

TABLE 5
Inhibitory concentration of the components of the
combinations (TCS & Geraniol) in different ratios

| | | MIC (μg/ml) | | | |
|---|---|---|---|---|---|
| | | Example 7 | | Example 8 | |
| S. | | TCS + Geraniol (1:20) | | TCS + Geraniol (1:80) | |
| No. | Organism | TCS | Geraniol | TCS | Geraniol |
| 1 | S. aureus | 0.32 | 6.51 | 0.65 | 13.02 |
| 2 | S. epidermidis | 1.3 | 26.04 | 1.3 | 104.16 |
| 3 | B. subtilis | 2.6 | 52.08 | 2.6 | 208.33 |
| 4 | C. albicans | 10.41 | 208.33 | 2.6 | 208.33 |
| 5 | A. niger | 5.2 | 104.16 | 2.6 | 208.33 |
| 6 | M. furfur | 1.3 | 26.04 | 0.65 | 13.02 |
| 7 | M. restricta | 5.2 | 104.16 | 1.3 | 104.16 |

As seen from the Table 5, combinations of TCS with Geraniol in different ratios surprisingly exhibit pronounced lowering of MIC values of individual components compared to that of the parent compound over wide compositional ranges and against wide ranges of organisms.

TABLE 6
Inhibitory concentration of the components of the combinations
(CMB, ZPTO, KTZ & LGO) in different ratios

| | | MIC (μg/ml) | | | | | |
|---|---|---|---|---|---|---|---|
| | | Example 9 | | Example 10 | | Example 11 | |
| | | CMB + LGO | | ZPTO + LGO | | KTZ + LGO | |
| S. | | (1:20) | | (1:40) | | (1:80) | |
| No. | Organism | CMB | LGO | ZPTO | LGO | KTZ | LGO |
| 1 | M. furfur | 0.32 | 6.51 | 0.24 | 9.76 | 0.08 | 6.51 |

As seen from the Table 6, combinations of CMB, ZPTO, KTZ with LGO in different ratios surprisingly exhibit pronounced lowering of MIC values of individual components compared to that of the parent compound over wide compositional ranges and against wide ranges of organisms.

The above Examples demonstrate that combinations of TCS, CMB, ZPTO, KTZ (antimicrobials) with LGO, Citral, Nerol, Geraniol (functionalized hydrocarbon and/or mixtures containing such functionalized hydrocarbons) in different ratios surprisingly exhibit pronounced lowering of MIC values than the parent compound over a wide compositional ranges and against wide ranges of organisms.

Fractional Inhibitory Concentration (FIC) Index was calculated from the Minimal Bactericidal/Fungicidal Concentration (MBC/MFC) by using the following equation:

$$FIC Index = \frac{\begin{matrix}MBC of drug A when \\ used in combination\end{matrix}}{MBC of Drug A} + \frac{\begin{matrix}MBC of drug B when \\ used in combination\end{matrix}}{MBC of Drug B}$$

An FIC Index of <0.5 was considered as synergistic effect; 0.5-1.0 was considered as additive effect, and >1.0 was considered as antagonistic effect.

Table 7 shows FIC Index of antimicrobials in combinations with functionalized hydrocarbon and/or mixtures containing such functionalized hydrocarbons against various microorganisms studied.

TABLE 7
FIC Index of combinations

| | | S. epider- | | | | | |
|---|---|---|---|---|---|---|---|
| Sample | S. aureus | midis | B. subtilis | C. albicans | Asp. niger | M. furfur | M. restricta |
| Example 1 | 0.676 | 0.207 | 0.042 | 0.499 | 0.666 | 0.686 | 0.374 |
| TCS + LGO | | | | | | | |
| (1:20) | | | | | | | |
| Example 2 | 0.374 | 0.665 | 0.093 | 0.249 | 0.416 | 0.343 | 0.343 |
| TCS + LGO | | | | | | | |
| (1:80) | | | | | | | |
| Example 3 | 0.092 | 0.498 | 0.352 | 0.499 | 0.666 | 0.686 | 0.374 |
| TCS + Citral | | | | | | | |
| (1:20) | | | | | | | |
| Example 4 | 0.374 | 0.998 | 0.207 | 0.124 | 0.832 | 0.343 | 0.343 |
| TCS + Citral | | | | | | | |
| (1:80) | | | | | | | |
| Example 5 | 0.082 | 0.186 | 0.171 | 0.833 | 0.499 | 0.186 | 0.416 |
| TCS + Nerol | | | | | | | |
| (1:20) | | | | | | | |
| Example 6 | 0.169 | 0.498 | 0.186 | 0.332 | 0.249 | 0.093 | 0.353 |
| TCS + Nerol | | | | | | | |
| (1:80) | | | | | | | |
| Example 7 | 0.165 | 0.186 | 0.186 | 0.833 | 0.186 | 0.186 | 0.416 |
| TCS + Geraniol | | | | | | | |
| (1:20) | | | | | | | |
| Example 8 | 0.335 | 0.249 | 0.249 | 0.332 | 0.124 | 0.093 | 0.353 |
| TCS + Geraniol | | | | | | | |
| (1:80) | | | | | | | |
| Example 9 | — | — | — | — | — | 0.33 | — |
| CMB + LGO | | | | | | | |
| (1:20) | | | | | | | |
| Example 10 | — | — | — | — | — | 0.31 | — |
| ZPTO + LGO | | | | | | | |
| (1:40) | | | | | | | |
| Example 11 | — | — | — | — | — | 0.332 | — |
| KTZ + LGO | | | | | | | |
| (1:80) | | | | | | | |

As seen from the Table 7, FIC Index shows synergistic activity for combinations of TCS CMB, ZPTO, KTZ (antimicrobials) with LGO, Citral, Nerol, Geraniol (functionalized hydrocarbon and/or mixtures containing such functionalized hydrocarbons) over wide compositional ranges.

The enhancement levels of compound A in the presence of another B was calculated as follows:

$$\begin{matrix}Enhancement factor of \\ \begin{matrix}compound A in presence \\ of Compound B\end{matrix}\end{matrix} = \frac{MBC of compound A alone}{\begin{matrix}MBC of compound A \\ in presence of B\end{matrix}}$$

Table 8 shows enhancement factor of antimicrobials (TCS, CMB, ZPTO & KTZ) in presence of LGO, Citral, Nerol & Geraniol (functionalized hydrocarbon and/or mixtures containing such functionalized hydrocarbons) in various ratios against various microorganisms:

TABLE 8
Enhancement factor of Antimicrobials

| | | S. epider- | | | | | |
|---|---|---|---|---|---|---|---|
| Sample | S. aureus | midis | B. subtilis | C. albicans | A. niger | M. furfur | M. restricta |
| Example 1 | 1.5× | 6× | 24× | 3× | 3× | 48× | 24× |
| TCS + LGO | | | | | | | |
| (1:20) | | | | | | | |
| Example 2 | 3× | 3× | 12× | 12× | 12× | 96× | 96× |
| TCS + LGO | | | | | | | |
| (1:80) | | | | | | | |
| Example 3 | 12× | 3× | 3× | 6× | 3× | 48× | 24× |
| TCS + Citral | | | | | | | |
| (1:20) | | | | | | | |
| Example 4 | 3× | 3× | 6× | 24× | 6× | 96× | 96× |
| TCS + Citral | | | | | | | |
| (1:80) | | | | | | | |
| Example 5 | 12× | 6× | 6× | 1.5× | 3× | 48× | 25× |
| TCS + Nerol | | | | | | | |
| (1:20) | | | | | | | |
| Example 6 | 6× | 3× | 6× | 6× | 12× | 96× | 48× |
| TCS + Nerol | | | | | | | |
| (1:80) | | | | | | | |
| Example 7 | 6× | 6× | 6× | 1.5× | 6× | 48× | 25× |
| TCS + Geraniol | | | | | | | |
| (1:20) | | | | | | | |
| Example 8 | 3× | 6× | 6× | 6× | 12× | 96× | 48× |
| TCS + Geraniol | | | | | | | |
| (1:80) | | | | | | | |
| Example 9 | — | — | — | — | — | 6× | — |
| CMB + LGO | | | | | | | |
| (1:20) | | | | | | | |
| Example 10 | — | — | — | — | — | 16× | — |
| ZPTO + LGO | | | | | | | |
| (1:40) | | | | | | | |
| Example 11 | — | — | — | — | — | 6× | — |
| KTZ + LGO | | | | | | | |
| (1:80) | | | | | | | |

As seen from the Table 8, in the presence of LGO, Citral, Nerol & Geraniol (functionalized hydrocarbon and/or mixtures containing such functionalized hydrocarbons), activity of TCS, CMB, ZPTO & KTZ (antimicrobials) is enhanced several folds. A phenomenal increase is seen especially against M. furfur and M. restricta.

Combinations of Triclosan and LGO, Citral, Nerol & Geraniol (functionalized hydrocarbon and/or mixtures containing such functionalized hydrocarbons) apart from giving an overall enhanced antimicrobial activity, was surprisingly showing significant anti-dandruff activity too.

### Example 14

### Estimation of MIC Values Against M. furfur with Shampoo Incorporated with Synergistic Compositions of the Present Invention

Synergistic compositions were of Triclosan and LGO & Nerol (functionalized hydrocarbon and/or mixtures containing such functionalized hydrocarbons) as described in Examples 1 & 2, as well as Examples 5 & 6, were prepared and incorporated in the shampoo base (Shampoo composition: SLES—36%, Palmkernalamide MEA—1%, Ethyleneglycol distearate—0.5%, Cocamidopropyl Betaine—6%, Lamesoft PO 65—1.5%, DC1870—5%, Salcare Super 7—0.75%, Jaguar Excel—0.1%, PEG 7 Glyceryl cocoate—1.5%, Disodium Ethylenediaminetetraacetic acid (EDTA)—0.05%, Triethanolamine TEA—0.3%, Color—0.0006%, Perfume 0.7%, Water—q.s). The MIC Values of the resultant shampoos were estimated via adaptation of the procedure described in Example 12. Table 9 & 10 shows the MIC values of shampoos incorporated with synergistic composition of the present invention and individual ingredients of the composition of the present invention.

TABLE 9
MIC values of shampoos incorporated with synergistic compositions
of the present invention against M. furfur.

| | | | | MIC (μg/ml) |
|---|---|---|---|---|
| S. | | | | of test |
| No | Composition (w/w in shampoo) | Example # | Ratio | shampoo |
| 1 | Shampoo Base (Control) | | — | 10000 |
| 2 | Base + 0.3% TCS + 6% LGO | Example 1 | 1:20 | 78.12 |
| 3 | Base + 0.03% TCS + 2.4% LGO | Example 2 | 1:80 | 78.12 |
| 4 | Base + 0.3% TCS + 6% Nerol | Example 5 | 1:20 | 78.12 |
| 5 | Base + 0.03% TCS + 2.4% Nerol | Example 6 | 1:80 | 156.25 |

TABLE 10
MIC values of shampoos incorporated with individual ingredients
of the compositions of the present invention against M. furfur.

| | Composition | MIC (μg/ml) of |
|---|---|---|
| S. No | (w/w in shampoo) | test shampoo |
| 1 | Base + 0.3% TCS | 1250 |
| 2 | Base + 0.03% TCS | 10000 |
| 3 | Base + 6% LGO | 625 |
| 4 | Base + 2.4% LGO | 2500 |
| 5 | Base + 6% Nerol | 1250 |
| 6 | Base + 2.4% Nerol | 2500 |

From Example 14 (Tables 9 & 10), it is evident that when these synergistic composition of the present invention are incorporated into products viz. shampoo, the synergistic effect is exhibited by significant lowering of the MIC value (Table 9) when compared with individual components being incorporated in the product base (Table 10). This indeed demonstrates the usefulness of such compositions as practical propositions for antimicrobial activities.

### Example 15

### Estimation of MIC Values of Hair Oil Incorporating Synergistic Compositions Against M. furfur

Synergistic compositions of TCS with LGO & Nerol (functionalized hydrocarbon and/or mixtures containing such functionalized hydrocarbons) as described in Examples 1 & 2, as well as Examples 5 & 6, were used and incorporated in a conventional hair oil base (Composition: Gingelly oil—25%, Coconut oil—25%, Mineral oil—49.8%, BHT 0.2%). The MIC values of the resultant oils were estimated via adaptation of the procedure described in Example 12. Table 11 & 12 shows the MIC values of hair oils incorporated with synergistic composition of the present invention and individual ingredients of the composition of the present invention.

TABLE 11
MIC values of Hair oil incorporated with synergistic
compositions against M. furfur.

| | | | | MIC (μg/ml) |
|---|---|---|---|---|
| S. | | | | of test |
| No | Composition (w/w in hair oil) | Example # | Ratio | hair oil |
| 1 | Hair oil Base (Control) | | — | 2500 |
| 2 | Base + 0.3% TCS + 6% LGO | Example 1 | 1:20 | 19.53 |
| 3 | Base + 0.03% TCS + 2.4% LGO | Example 2 | 1:80 | 39.06 |
| 4 | Base + 0.3% TCS + 6% Nerol | Example 5 | 1:20 | 39.06 |
| 5 | Base + 0.03% TCS + 2.4% Nerol | Example 6 | 1:80 | 19.53 |

TABLE 12
MIC values of Hair oil incorporated with incorporated with individual
ingredients of the compositions against M. furfur.

| | Composition | MIC (μg/ml) of |
|---|---|---|
| S. No | (w/w in hair oil) | test hair oil |
| 1 | Base + 0.3% TCS | 78.12 |
| 2 | Base + 0.03% TCS | 312.5 |
| 3 | Base + 6% LGO | 156.25 |
| 4 | Base + 2.4% LGO | 625 |
| 5 | Base + 6% Nerol | 156.25 |
| 6 | Base + 2.4% Nerol | 1250 |

From the Example 15 (Tables 11 & 12), it is evident that when these synergistic composition of the present invention are incorporated into products, the synergistic effect is exhibited by significant lowering of the MIC (Table 11) value when compared with individual components being incorporated in product base (Table 12). This indeed demonstrates the usefulness of such compositions as practical propositions for antimicrobial activities.

### Example 16

### Estimation of MIC Values of Hair Gel Incorporating Synergistic Compositions Against M. furfur

Synergistic compositions were of TCS with LGO & Nerol (functionalized hydrocarbon and/or mixtures containing such functionalized hydrocarbons) as described in Examples 1 & 2, as well as Examples 5 & 6, were used and incorporated in a conventional hair gel base (Composition: Carbopol—0.5%, PVP/VA Polymer—2.45%, Glycerin—1.5%, Panthenal—0.2%, Glydant—0.3%, Aloe vera extract—0.1%, Kerasal—0.05%, Calcunent—0.001%, TEA—0.70%, Water—q.s). The MIC values of the resultant gels were estimated via adaptation of the procedure described in Example 12. Table 13 & 14 shows the MIC values of hair gels incorporated with synergistic composition of the present invention and individual ingredients of the composition of the present invention.

TABLE 13
MIC values of Hair gel incorporated with synergistic
compositions against M. furfur.

| | | | | MIC (μg/ml) |
|---|---|---|---|---|
| S. | | | | of test |
| No | Composition (w/w in hair gel) | Example | Ratio | hair gel |
| 1 | Hair gel Base (Control) | | — | 10000 |
| 2 | Base + 0.3% TCS + 6% LGO | Example 1 | 1:20 | 156.25 |
| 3 | Base + 0.03% TCS + 2.4% LGO | Example 2 | 1:80 | 312.5 |
| 4 | Base + 0.3% TCS + 6% Nerol | Example 5 | 1:20 | 312.5 |
| 5 | Base + 0.03% TCS + 2.4% Nerol | Example 6 | 1:80 | 625 |

TABLE 14
MIC values of Hair gel incorporated with individual
ingredients of the compositions against M. furfur.

| | Composition | MIC (μg/ml) |
|---|---|---|
| S. No | (w/w in hair gel) | of test hair gel |
| 1 | Base + 0.3% TCS | 2500 |
| 2 | Base + 0.03% TCS | 10000 |
| 3 | Base + 6% LGO | 625 |
| 4 | Base + 2.4% LGO | 2500 |
| 5 | Base + 6% Nerol | 2500 |
| 6 | Base + 2.4% Nerol | 10000 |

From the Example 16 (Tables 13 & 14), it is evident that when these synergistic composition of the present invention are incorporated into products, the synergistic effect is exhibited by significant lowering of the MIC value (Table 13) when compared with individual components being incorporated in product base (Table 14). This indeed demonstrates the usefulness of such compositions as practical propositions for antimicrobial activities.

### Example 17

### Estimation of MIC Values of Skin Lotion Incorporating Synergistic Compositions Against S. aureus and C. albicans

Synergistic compositions were of TCS with LGO & Nerol (functionalized hydrocarbon and/or mixtures containing such functionalized hydrocarbons) as described in Examples 1 & 2, as well as Examples 5 & 6, were used and incorporated in a conventional skin lotion base (Composition: LLP—10%, WPJ—1%, CCTG—2%, Cetyl alcohol—0.5%, Myrj 59—2%, GMS-Se—1%, Cetyl palmitate—1%, Dimethicone—2%, Stearic acid—3%, Olive oil—0.2%, EDTA—0.05%, Glycerin—5%, KOH—0.2%, D.M. Water—q.s to 100%.). The MIC values of the resultant skin lotions were estimated via adaptation of the procedure described in Example 12. Table 15 & 16 shows the MIC values of hair gels incorporated with synergistic composition of the present invention and individual ingredients of the composition of the present invention.

TABLE 15
MIC values of skin lotion incorporated with synergistic compositions
against S. aureus and C. albicans.

| S. | Composition | | | MIC (μg/ml) | |
|---|---|---|---|---|---|
| No | (w/w in skin lotion) | Example # | Ratio | S. aureus | C. albicans |
| 1 | Skin lotion Base (Control) | | — | >20000 | >20000 |
| 2 | Base + 0.3% TCS + 6% LGO | Example 1 | 1:20 | 1250 | 312.5 |
| 3 | Base + 0.03% TCS + 2.4% LGO | Example 2 | 1:80 | 2500 | 625 |
| 4 | Base + 0.3% TCS + 6% Nerol | Example 5 | 1:20 | 2500 | 312.5 |
| 5 | Base + 0.03% TCS + 2.4% Nerol | Example 6 | 1:80 | 2500 | 625 |

TABLE 16
MIC values of skin lotion incorporated with individual ingredients
of the compositions against S. aureas and C. albicans.

| | |
|---|---|
| Composition | MIC (μg/ml) |

| S. No | (w/w in skin lotion) | S. aureus | C. albicans |
|---|---|---|---|
| 1 | Base + 0.3% TCS | 5000 | 5000 |
| 2 | Base + 0.03% TCS | >20000 | >20000 |
| 3 | Base + 6% LGO | 5000 | 2500 |
| 4 | Base + 2.4% LGO | 20000 | 10000 |
| 5 | Base + 6% Nerol | 10000 | 5000 |
| 6 | Base + 2.4% Nerol | 20000 | 10000 |

From the Example 17 (Tables 15 & 16), it is evident that when these synergistic composition of the present invention are incorporated into products, the synergistic effect is exhibited by significant lowering of the MIC value (Table 15) when compared with individual components being incorporated in product base (Table 16). This indeed demonstrates the usefulness of such compositions as practical propositions for antimicrobial activities.

### ADVANTAGES OF THE PRESENT INVENTION

1. The composition provides antimicrobial properties at concentrations much below the levels at which similar properties are delivered by the single ingredient alone thereby making it more efficacious (See Tables 1-6).

2. The composition facilitates better inhibition of wider range of microorganisms as compared to the individual component of the composition (See Tables 1-5).

3. The synergistic compositions are applicable to the control of bacterial and fungal growth in cosmetic/personal care (hair care, skin care) and home care (hard surface, other surface cleaning), which otherwise with only the individual component may not have been effective. Such products include, but are not limited to shampoos, conditioners, hair wash powders, hair oils, gels, creams, lotions, cleaners, liquid soaps, soaps, scrubs, microbicidal washes, tooth pastes/gels, mouthwashes/rinses, deodorants, antiperspirants, surface cleaners, and the like.

4. The synergistic composition reduces the amount of antimicrobial agent which not only reduces the cost but also provides use of lower concentration of the agent thereby reducing the exposure of the agent and consequently the side effects if any on the user.

5. Use of lower concentration of the antimicrobial agent also renders it more environment friendly.

1. A synergistic antimicrobial composition containing an antimicrobial agent and at least one functionalized hydrocarbon and/or mixtures containing such functionalized hydrocarbons.

2. A synergistic antimicrobial composition as claimed in claim 1 wherein the ratio of antimicrobial agent and at least one functionalized hydrocarbon and/or mixtures containing such functionalized hydrocarbons being in the range of 1:5-1:100.

3. A synergistic antimicrobial as claimed in claim 1 wherein the composition containing TCS as the antimicrobial agent and at least one functionalized hydrocarbon and/or mixtures containing such functionalized hydrocarbons.

4. A synergistic antimicrobial composition as claimed in claim 3 wherein the composition containing TCS as the antimicrobial agent and at least one functionalized hydrocarbon and/or mixtures containing such functionalized hydrocarbons, the ratio of TCS and the functionalized hydrocarbon and/or mixtures containing such functionalized hydrocarbons being 1:5-1:100.

5. A synergistic antimicrobial composition as claimed in claim 1 wherein the functionalized hydrocarbon and/or mixtures containing such functionalized hydrocarbons is selected from a saturated/unsaturated; linear/branched/cyclic hydrocarbon; having 6-20 carbon atoms; the functional groups present in the hydrocarbon being hydroxyl, carbonyl, carboxyl, amino groups or derivatives thereof, such as monoterpenes, mixtures containing such monoterpenes such like essential oils.

6. A synergistic antimicrobial composition as claimed in claim 4 wherein the ratio of TCS to that of functionalized hydrocarbon and/or mixtures containing such functionalized hydrocarbons is in the ratio of between 1:10-1:90, and more preferably between 1:20-1:80.

7. A process for the preparation of a synergistic antimicrobial composition as claimed in claim 1 which comprises mixing an antimicrobial agent and at least one functionalized hydrocarbon and/or mixtures containing such functionalized hydrocarbons.

8. A process for the preparation of a synergistic antimicrobial composition as claimed in claim 2 which comprises mixing an antimicrobial agent and at least one functionalized hydrocarbon and/or mixtures containing such functionalized hydrocarbons in the ratio of 1:5-1:100.

9. A process for the preparation of a synergistic antimicrobial composition as claimed in claim 4 which comprises mixing TCS as the antimicrobial agent and at least one functionalized hydrocarbon and/or mixtures containing such functionalized hydrocarbons.

10. A process for the preparation of a synergistic antimicrobial composition as claimed in claim 9 wherein, the ratio of TCS and functionalized hydrocarbon and/or mixtures containing such functionalized hydrocarbons used being in the range of 1:5-1:100 preferably in the range of 1:10-1:90 and more preferably between 1:20-1:80.

11. Products such as shampoo, gel, cream, lotions conditioners, hair wash powders, hair and body oils, creams, lotions, cleansers, toners, liquid soaps, soaps, scrubs, microbicidal washes, toothpastes/gels, mouthwashes, deodorants, antiperspirants, surface cleaners and the like
containing the composition as claimed in claim 1.

12. Products as claimed in claim 11 containing in addition, but not limited to water, surfactants, thickeners, gelling agents, hydrophobic/hydrophilic polymers, emulsifying agents, emollients or their mixtures, humectants, perfumes, colours, functional ingredients and the like.

13-15. (canceled)
